(19) United States
(12) Patent Application Publication
(10) Pub. No.: US 2025/0326173 A1
(43) Pub. Date: Oct. 23, 2025

(54) A PROCESS FOR THE PREPARATION OF BIODEGRADABLE NET ARTICLES

(71) Applicant: Reliance Industries Limited, Mumbai (IN)

(72) Inventors: Virendrakumar Gupta, Navi Mumbai (IN); Ashwin Khasgiwala, Mumbai (IN); Sunil Dhamaniya, Jaipur (IN)

(73) Assignee: Reliance Industries Limited, Mumbai (IN)

(21) Appl. No.: 18/864,811

(22) PCT Filed: May 12, 2023
(86) PCT No.: PCT/IB2023/054935

§ 371 Date: Nov. 11, 2024

(30) Foreign Application Priority Data
May 12, 2022 (IN) 202221027255

(51) Int. Cl. B29C 48/05; B29C 48/00; B29C 48/345; B29C 48/36; B29C 48/90; B29D 28/00; B29K 67/00; B29K 509/02; B29L 28/00; C08K 3/34; C08L 67/02

(52) U.S. Cl. CPC B29C 48/05; B29C 48/0018; B29C 48/022; B29C 48/345; B29C 48/36; B29C 48/905; C08K 3/34; C08L 67/02; B29C 2948/92552; B29C 2948/9259; B29C 2948/92704; B29D 28/00; B29K 2067/046; B29K 2509/02; B29K 2995/0012; B29K 2995/0053; B29K 2995/006; B29K 2995/0063; B29K 2995/0097; B29L 2028/00; C08K 2201/005

(57) ABSTRACT

The present disclosure relates to a process for the preparation of biodegradable net articles. The process is easy to perform and cost-effective. The biodegradable net articles of the present disclosure have comparatively higher melting strengths, good flexibility, better orientability, and high tensile strength. The biodegradable net articles of the present disclosure are environmentally friendly. The articles such as bags made by the biodegradable net of the present disclosure are suitable for packaging applications.

### FIELD

The present disclosure relates to a process for the preparation of biodegradable net and articles made therefrom. Particularly, the present disclosure relates to a process for the preparation of biodegradable net suitable for packaging applications; and articles such as bags prepared from the biodegradable nets.

### Definitions

As used in the present disclosure, the following terms are generally intended to have the meaning as set forth below, except to the extent that the context in which they are used indicate otherwise.

The term “biodegradable” refers to the ability of things to get disintegrated (decomposed) by the action of micro-organisms such as bacteria or fungi (with or without oxygen) while getting assimilated into the natural environment.

The term “net” refers to a material in which the yarns/filaments/strands are fused, looped or knotted at their intersections, resulting in a structure with open spaces between the yarns/filaments/strands.

The term “compounding” refers to a process that includes melt-blending of the basic plastic materials with specific additives and agents to customise the colour, thermal, physical, aesthetic and electrical characteristics of the material, to make it more effective, efficient and uniform.

The term “take off” refers to an instrument or part of the instrument which is used for taking out the extruded net at the exit of a die from the first water bath and conveyed to the second water bath.

The term “extrusion die” or “die” refers to an assembly with a metal restrictor or channel capable of providing a constant cross-sectional profile to a stream of polymer.

The term “die member” refers to a rotating component of the extrusion die assembly, configured to provide an infinite variation in relative rotational motion between the rotating components, i.e. die members.

### BACKGROUND

The background information herein below relates to the present disclosure but is not necessarily prior art.

Conventionally, polymers such as polyethylene (PE), polypropylene (PP), and nylon are used for preparing net articles that are used in the packaging sector. Conventional packaging articles are usually discarded after their first use, thereby causing a detrimental effect on the environment. Conventionally, the polymers can be blended to form a composite. Polymer composites are widely used in extrusion and moulding applications to prepare flexible and rigid articles.

The demand for biodegradable and compostable plastics is increasing globally to mitigate the environmental pollution caused by non-degradable plastic waste. Biodegradable polymers are significantly used in the packaging sector for single-use applications such as flexible and rigid packaging. Biodegradable polymers have certain limitations related to processing and end-product properties.

Therefore, there is felt a need for a process for the preparation of biodegradable net articles and articles produced using biodegradable nets which can mitigate the drawbacks mentioned hereinabove or at least provide an alternative solution.

### Objects

Some of the objects of the present disclosure, which at least one embodiment herein satisfies, are as follows:

An object of the present disclosure is to ameliorate one or more problems of the prior art or to at least provide a useful alternative.

Another object of the present disclosure is to provide a process for the preparation of a biodegradable net article.

Yet another object of the present disclosure is to provide a simple and cost-effective process for the preparation of a biodegradable net article.

Another object of the present disclosure is to provide a biodegradable net article.

Yet another object of the present disclosure is to provide a biodegradable net article that has comparatively higher mechanical strength.

Still another object of the present disclosure is to provide a biodegradable net article that is environmentally friendly.

Yet another object of the present disclosure is to provide an article produced by using a biodegradable net.

Still another object of the present disclosure is to provide an article produced by using a biodegradable net that has a higher holding capacity.

Yet another object of the present disclosure is to provide an article produced by using a biodegradable net that is suitable for packaging.

Still another object of the present disclosure is to provide an article produced by using a biodegradable net that has good aesthetics.

Other objects and advantages of the present disclosure will be more apparent from the following description, which is not intended to limit the scope of the present disclosure.

### SUMMARY

The present disclosure relates to a process for the preparation of a biodegradable net article. The process comprises compounding at least one biodegradable polymer and at least one additive to obtain pellets of the biodegradable polymer composition. Thereafter, the pellets are dried at a first predetermined temperature for a predetermined time period to obtain dried pellets. The dried pellets are then extruded by using a means for extrusion at a second predetermined temperature to obtain a plurality of individually extruded strands forming an extruded net in the form of a net sleeve, wherein the means for extrusion comprises a plurality of grooved die members having a plurality of orifices. The extruded net is then quenched at a third predetermined temperature to obtain a quenched net. The quenched net is then stretched at a predetermined stretch ratio in at least one fluid bath having a fourth predetermined temperature to obtain a stretched net. Thereafter, the stretched net is sealed at a fifth predetermined time period to obtain the biodegradable net article.

The present disclosure also relates to a biodegradable net comprising a plurality of strands having a predetermined thickness, and the strands interconnected such that each set of strands has an orifice of a predetermined diameter.

The present disclosure also provides an article using the net. The article is suitable for packaging, wherein the article has a holding capacity in the range of 50 grams to 5 kg.

### BRIEF DESCRIPTION OF THE ACCOMPANYING DRAWINGS

The present disclosure will now be described with the help of the accompanying drawing, in which:

FIG. 1 illustrates an image of an extruded netting at the outlet of the die having a square-shaped orifice in accordance with an embodiment of the present disclosure; and

FIG. 2 illustrates an image of a stretched netting having a diamond-shaped orifice in accordance with an embodiment of the present disclosure.

### DETAILED DESCRIPTION

The present disclosure relates to a process for the preparation of a biodegradable net and an article produced using the net. Particularly, the present disclosure relates to a process for the preparation of biodegradable nets and articles made therefrom. More particularly, the present disclosure relates to a process for the preparation of biodegradable net articles suitable for packaging applications; and articles such as bags using biodegradable nets.

Embodiments, of the present disclosure, will now be described with reference to the accompanying drawing.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

As used herein, the term “and/or” includes any and all combinations of one or more of the associated listed elements.

The terms first, second, third, etc., should not be construed to limit the scope of the present disclosure as the aforementioned terms may be only used to distinguish one element, component, region, layer or section from another component, region, layer or section. Terms such as first, second, third etc., when used herein do not imply a specific sequence or order unless clearly suggested by the present disclosure.

Conventionally, polymers such as polyethylene (PE), polypropylene (PP), and nylon are used for preparing net articles that are used in the packaging sector. Conventional packaging articles are usually discarded after their first use, thereby causing a detrimental effect on the environment. Conventionally, the polymers can be blended to form a composite. Polymer composites are widely used in extrusion and moulding applications to prepare flexible and rigid articles.

The demand for biodegradable and compostable plastics is increasing globally to mitigate the environmental pollution caused by non-degradable plastic waste. Biodegradable polymers are significantly used in the packaging sector for single-use applications such as flexible and rigid packaging.

The present disclosure provides a process for the preparation of a biodegradable net article and an article made therefrom.

In an aspect of the present disclosure, there is provided a process for the preparation of a biodegradable net article.

The process comprises compounding at least one biodegradable polymer and at least one additive to obtain pellets of the biodegradable polymer composition. Thereafter, the pellets are dried at a first predetermined temperature, for a predetermined time period to obtain dried pellets. The dried pellets are then extruded using a means for extrusion at a second predetermined temperature to obtain a plurality of individually extruded strands forming an extruded net in the form of a sleeve, wherein the means for extrusion comprises a plurality of grooved die members having a plurality of orifices. The extruded net is then quenched at a third predetermined temperature to obtain a quenched extruded net. The quenched extruded net is then stretched at a predetermined stretch ratio in at least one fluid bath having a fourth predetermined temperature to obtain a stretched net. The stretched net is then sealed at a fifth predetermined temperature to obtain the biodegradable net article.

The process is described in detail herein below:

In a first step, at least one biodegradable polymer and at least one additive are compounded to obtain pellets of biodegradable composition.

In accordance with the embodiments of the present disclosure, the compounding process is performed by adding fillers to biodegradable polymers and melt-blending to obtain a biodegradable polymer composition in pellet form.

In accordance with the embodiments of the present disclosure, a biodegradable polymer composition comprises the following:
a. at least one copolymer of aromatic diacid, aliphatic diacid, and aliphatic diol in an amount in the range of 60 wt % to 95 wt % with respect to the total weight of the composition;
b. at least one biodegradable polymer in an amount in the range of 5 wt % to 40 wt % with respect to the total weight of the composition;
c. at least one additive, wherein said additive comprises the following:
   i. at least one filler in an amount in the range of 1 wt % to 30 wt % with respect to the total weight of the composition;
   ii. optionally at least one branching agent in an amount in the range of 0.05 wt % to 2 wt % with respect to the total weight of the composition;
   iii. optionally at least one thermal stabilizer in an amount in the range of 0.05 wt % to 2 wt % with respect to the total weight of the composition;
   iv. optionally at least one compatibilizer in an amount in the range of 0.05 wt % to 2 wt % with respect to the total weight of the composition.

In accordance with the present disclosure, the aromatic diacid can be at least one selected from the group consisting of terephthalic acid, dimethyl terephthalate, phthalic acid, phthalic anhydride, isophthalic acid, dimethyl isophthalate, 4-methylphthalic acid, 4-methylphthalic anhydride, dimethyl phthalate, naphthalene dicarboxylic acid, and its derivatives, and diphenyl ether dicarboxylic acid and its derivatives. In a preferred embodiment, the aromatic diacid is terephthalic acid.

In accordance with the present disclosure, the aliphatic diacid can be at least one selected from the group consisting of oxalic acid, malonic acid, succinic acid, glutaric acid, adipic acid, pimelic acid, suberic acid, azelaic acid, sebacic acid, undecanedioic acid, dodecanedioic acid, brassylic acid, tetradecanedioic acid, and its derivatives. In a preferred embodiment, the aliphatic diacid is adipic acid.

In accordance with the present disclosure, the aliphatic diol can be at least one selected from the group consisting of ethylene glycol, 1,2-propanediol, 1,3-propanediol, 1,2-butanediol, 1,4-butanediol, 1,5-pentanediol, 1,6-hexanediol, 2,4-dimethyl-2-ethyl-1,3-hexanediol. In a preferred embodiment, the aliphatic diol is 1,4-butanediol.

In accordance with the present disclosure, the biodegradable polymer can be at least one selected from the group consisting of polylactic acid (PLA), polybutylene succinate (PBS), Polybutylene succinate adipate (PBSA), poly(butylene adipate-co-terephthalate) (PBAT) and polybutylene succinate adipate terephthalate (PBSAT). In an exemplary embodiment, the biodegradable polymer is poly(butylene adipate-co-terephthalate) (PBAT). The PBAT polymer is a random copolymer of butylene terephthalate and butylene adipate units. The butylene terephthalate units construct the aromatic component of the polymer that brings mechanical strength to the copolymer. The butylene adipate units construct the aliphatic component of the polymer that brings biodegradation characteristics in the copolymer. PBAT and PLA are compostable polymers having degradation up to 90% in thermophilic compost conditions in 180 days (ASTM D 6400).

In accordance with an embodiment of the present disclosure, the copolymer of aromatic diacid, aliphatic diacid, and aliphatic diol is poly(butylene adipate-co-terephthalate) (PBAT).

In accordance with an embodiment of the present disclosure, the copolymer of aromatic diacid, aliphatic diacid, and aliphatic diol is present in an amount in the range of 60 weight % to 95 mass % with respect to the total mass of the composition.

In accordance with an embodiment of the present disclosure, the biodegradable polymer is present in an amount in the range of 5 weight % to 40 weight % with respect to the total mass of the composition.

In accordance with the embodiments of the present disclosure, the additive is at least one selected from the group consisting of a filler, a branching agent, a thermal stabilizer and a compatibilizer.

In accordance with the present disclosure, the filler can be at least one selected from the group consisting of calcium carbonate, talc, silica, silicates, and fly ash. In an exemplary embodiment, the filler is talc. The fillers help to enhance the crystallization temperature of the polymer. This facilitates the process for faster cooling and enhances the rate of production, as the inorganic fillers work as a nucleating agent. Thus, in comparison with the neat polymer, the composition with inorganic filler of the present disclosure facilitates a faster cooling upon extrusion of nets, thus enhancing the rate of production. Secondly, the use of filler in the composition is very helpful for cost reduction.

The amount of filler is in the range of 1 weight % to 30 mass % with respect to the total mass of the composition.

In accordance with the present disclosure, the branching agent can be at least one selected from the group consisting of glycerol, pentaerythritol, 1,1,1-trimethylolethane, 1,2,4-butanetriol, trimellitic acid, pyromellitic acid, trimethylolethane, polyethertriols, trimesic acid, pyromellitic acid and hydroxyisophthalic acid. In a preferred embodiment, the branching agent is pentaerythritol.

In accordance with an embodiment of the present disclosure, the compatibilizer can be selected from maleic anhydride (MA), maleic anhydride grafted PLA, epoxidized soybean oil, and castor oil. In a preferred embodiment, the compatibilizer is maleic anhydride.

In an exemplary embodiment, the biodegradable polymer composition comprises PBAT (80%), PLA (10%), and Talc (10%).

In accordance with an embodiment of the present disclosure, the biodegradable polymer composition comprises at least one copolymer of aromatic diacid, aliphatic diacid, and aliphatic diol, at least one biodegradable polymer, at least one filler, optionally at least one branching agent, optionally at least one thermal stabilizer and optionally at least one compatibility agent.

In an exemplary embodiment, the biodegradable polymer composition comprises poly(butylene adipate-co-butylene terephthalate), poly(lactic acid) and talc.

In an exemplary embodiment, the biodegradable polymer composition comprises:
poly(butylene adipate-co-butylene terephthalate) having MFI (ASTM D 1238) in the range of 5 g/10 min to 8 g/10 min at 190° C., material density in the range of 1.21 g/cm³ to 1.25 g/cm³, and melting temperature in the range of 115° C. to 125° C.;
poly(lactic acid) having MFI (ASTM D 1238) in the range of 4 to 8 g/10 min at 210° C., and material density in the range of 1.25 g/cm³ to 1.28 g/cm³; and
talc having particle size 5.0±0.5μ D (50), and bulk density 375±30 g/ltr.

In an exemplary embodiment, the biodegradable polymer composition is characterized by having:
MFI (ASTM D 1238) in the range of 5 g/10 min to 7 g/10 min at 190° C.;
material density in the range of 1.25 g/cm³ to 1.29 g/cm³;
melting temperature in the range of 120° C. to 150° C.;
glass transition temperature of 55.0° C.; and
crystallization temperature of 91.5° C.

In accordance with an embodiment of the present disclosure, the preparation of biodegradable composition comprises the step of blending at least one copolymer of aromatic diacid, aliphatic diacid, and aliphatic diol, at least one biodegradable polymer, at least one filler, optionally at least one branching agent, and, optionally at least one additive at a temperature in the range of 100° C. to 220° C. to obtain the biodegradable polymer composition. The biodegradable polymer of the present disclosure is characterized by having good mechanical, thermal and biodegradable properties.

In an embodiment, the biodegradable polymer is prepared by compounding process using PBAT (80%), PLA (10%) and Talc (10%) at a temperature in the range of 130° C. to 200° C.

In accordance with an embodiment of the present disclosure, the pellets have dimensions in the range of 2 mm to 4 mm. In an exemplary embodiment, the granules have 3 mm dimensions.

Thereafter, the pellets are dried at a first predetermined temperature, for a predetermined time period to obtain dried pellets.

In accordance with an embodiment of the present disclosure, the first predetermined temperature is in the range of 60° C. to 100° C. In a preferred embodiment, the first predetermined temperature is 80° C.

In accordance with an embodiment of the present disclosure, the predetermined time period is in the range of 1 hour to 4 hours. In a preferred embodiment, the predetermined time period is 2 hours.

In a second step, pellets are extruded using a means for extrusion at a second predetermined temperature to obtain a plurality of individually extruded strands forming an extruded net in the form of a net sleeve, wherein the means for extrusion comprises a plurality of grooved die members having a plurality of orifices.

In accordance with an embodiment of the present disclosure, the second predetermined temperature is in the range of 100° C. to 230° C. In a preferred embodiment, the second predetermined temperature is 100° C. to 190° C.

In accordance with an embodiment of the present disclosure, the step of extruding comprises the extrusion of a plurality of strands by rotation of at least one die member in one direction and joints formed by rotation of at least one die member in the opposite direction.

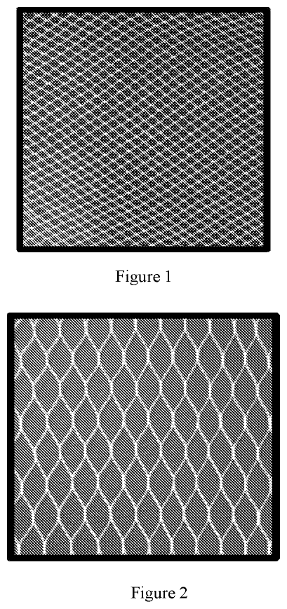

In accordance with an embodiment of the present disclosure, the orifice of extruded netting at the outlet of the die has orifices/openings of a square shape structure. FIG. 1 illustrates an image of an extruded netting at the outlet of the die having square shaped orifice/opening in accordance with an embodiment of the present disclosure.

In accordance with an embodiment of the present disclosure, the extruding comprises extrusion of a plurality of strands by rotation of at least one grooved die member in one direction and joints formed by rotation of at least one grooved die member in the opposite direction, wherein the grooved die members are coaxial.

In accordance with an embodiment of the present disclosure, the means for extrusion comprises an outer die member and an inner die member, wherein the members are coaxial and have grooves for joining plurality of individually extruded strands.

In accordance with an embodiment of the present disclosure, the forming the extruded net comprises an opposite sense of rotation of the outer die member and the inner die member at a predetermined angular speed. During the process, when the die members rotate, extrusion of a plurality of strands is done by rotation of at least one grooved die member in one direction and joints formed by rotation of at least one grooved die member in the opposite direction, wherein the grooved die members are coaxial.

In accordance with an embodiment of the present disclosure, the forming of the extruded net comprises an opposite rotation of said grooved die members at a predetermined angular speed to extrude strands and sequentially join the strands to form the net sleeve.

In accordance with an embodiment of the present disclosure, the die members are driven using a motor having a frequency in the range of 25 Hz to 40 Hz. In an exemplary embodiment, the die members are driven using a motor having a frequency is 33 to 34 Hz.

In accordance with the present disclosure, when the frequency of the motor increases, the cross section area of the net will become smaller. Thus the frequency of motor is inversely proportional to the cross-sectional area of the net orifice.

The angular speed of rotation of the die members is calculated by the following formula:

1 Hz=2π rad/s (wherein π is 3.142)

In accordance with the embodiments of the present disclosure, the angular speed of rotation of the die members is in the range of 125 rad/sec to 252 rad/sec. In an exemplary embodiment, the angular speed of rotation of the die members is 207 rad/sec to 214 rad/sec.

In accordance with an embodiment of the present disclosure, the plurality of orifices is in the range of 40 to 80. In an exemplary embodiment, the orifices are 55.

In a third step, the obtained extruded net is quenched at a third predetermined temperature to obtain a quenched extruded net.

In accordance with the embodiments of the present disclosure, the third predetermined temperature is in the range of 10° C. to 30° C. In an exemplary embodiment, the third predetermined temperature is 25° C.

In a fourth step, the extruded net is stretched at a predetermined stretch ratio in a fluid bath having a fourth predetermined temperature to obtain a stretched net. The fluid bath enhances the mechanical properties in terms of tensile strength.

In accordance with the present disclosure, the extruded netting at the outlet of the die has a square shaped orifices/openings, which are converted into a diamond shape once the netting gets stretched in a certain ratio. FIG. 2 illustrates an image of a stretched netting having a diamond-shaped orifices/openings in accordance with an embodiment of the present disclosure.

In accordance with the present disclosure, the fluid bath is a water bath.

In accordance with the present disclosure, the fourth predetermined temperature is in the range of 55° C. to 70° C. In an exemplary embodiment, the fourth predetermined temperature is 60° C.

In accordance with the present disclosure, the stretching is done in at least one direction selected from machine direction and transverse direction. In an exemplary embodiment, the stretching is done in the machine direction.

In accordance with the present disclosure, the predetermined stretch ratio is in the range of 1:1 to 1:6. In an exemplary embodiment, the predetermined stretch ratio is 1:3.

In a fifth step, the stretched net is sealed at a fifth predetermined temperature to obtain a biodegradable net article.

In accordance with an embodiment of the present disclosure, the stretched net is sealed at a fifth predetermined temperature for a predetermined holding time to obtain a biodegradable net article.

In accordance with an embodiment of the present disclosure, the biodegradable net article is a biodegradable net bag. Thus, after sealing, the biodegradable net is converted into net-bags.

In accordance with the present disclosure, the process step of sealing is followed by cutting and sealing of the prepared net bags/nettings.

In accordance with the embodiments of the present disclosure, the fifth predetermined temperature is in the range of 200° C. to 320° C. In an exemplary embodiment, the fifth predetermined temperature is 300° C.

In accordance with the embodiments of the present disclosure, the predetermined holding time is in the range of 2 seconds to 5 seconds. In an exemplary embodiment, the predetermined holding time is 3 seconds.

In accordance with the present disclosure, the strand has a thickness in the range of 50 microns to 200 microns. In an exemplary embodiment, the thickness is 150 microns.

In accordance with the present disclosure, the nets are cut in the size of 10 inches to 30 inches. In an exemplary embodiment, the nets are cut into a size of 20 inches.

In accordance with the embodiments of the present disclosure, the articles prepared using the process of the present disclosure are compostable having degradation up to 90% in thermophilic compost conditions in 180 days. (ASTM D 6400).

In another aspect, the present disclosure provides a biodegradable net. The net comprises a plurality of strands having a predetermined thickness, and strands interconnected such that each set of strands has orifices/openings of a predetermined diameter.

In accordance with the present disclosure, the strand has a thickness in the range of 50 microns to 200 microns. In an exemplary embodiment, the thickness is 150 microns.

In a fifth step, the stretched net is sealed at a fifth predetermined temperature and a predetermined holding time to obtain a biodegradable net.

In accordance with the present disclosure, the nettings are cut in the size of 10 inches to 30 inches. In an exemplary embodiment, the nettings are cut into a size of 20 inches.

In accordance with the present disclosure, after cutting, the nettings are sealed at one end at pre-determined temperature in the range of 200° C. to 320° C.

In accordance with the present disclosure, the biodegradable net is characterized by having:
i. a tensile strength in the range of 10 MPa to 15 MPa;
ii. elongation in the range of 100% to 130%; and

In accordance with the present disclosure, the orifice of the biodegradable net is a diamond shape.

In yet another aspect, the present disclosure provides an article produced using the biodegradable net of the present disclosure.

The article is suitable for packaging, preferably in the form of bags, and has a holding capacity in the range of 50 grams to 5 kg.

The produced net bags (net-articles) have applications in packaging, such as in freshly produced packaging (for packaging of fruits and vegetables), in single-use net-wrap, home furnishing applications, as laundry bags, consumable articles packaging, packaging of commodity items and the like.

The foregoing description of the embodiments has been provided for purposes of illustration and not intended to limit the scope of the present disclosure. Individual components of a particular embodiment are generally not limited to that particular embodiment but are interchangeable. Such variations are not to be regarded as a departure from the present disclosure, and all such modifications are considered to be within the scope of the present disclosure.

The present disclosure is further described in light of the following experiments which are set forth for illustration purpose only and not to be construed for limiting the scope of the disclosure. The following experiments can be scaled up to industrial/commercial scale and the results obtained can be extrapolated to industrial scale.

### Experimental Details

Details of a Biodegradable Polymer Composition in Accordance with the Present Disclosure:

Poly(butylene adipate-co-butylene terephthalate) was having MFI (ASTM D 1238) in the range of 5 to 8 g/10 min at 190° C., 2.16 kg: material density in the range of 1.21 to 1.25 g/cm³: melting temperature in the range of 115° C. to 125° C. Poly(lactic acid) was having MFI (ASTM D 1238) in the range of 4 to 8 g/10 min at 210° C., 2.16 kg: material density in the range of 1.25 to 1.28 g/cm³: Talc was having particle size 5.0±0.5μ D (50): bulk density 375±30 g/ltr.

The biodegradable polymer composition comprises PBAT (80%), PLA (10%), and Talc (10%).

The biodegradable polymer composition was found to have the following characteristics:
MFI (ASTM D 1238) in the range of 5 to 7 g/10 min at 190° C.: 2.16 kg;
material density in the range of 1.25 to 1.29 g/cm³;
melting temperature in the range of 120° C. to 150° C.;
glass transition temperature of 55.0° C. and −32.4° C.; and
crystallization temperature 91.5° C.
   Experiment 1: Process for the Preparation of Biodegradable Net Bags in Accordance with the Present Disclosure:

25 kg of the biodegradable polymer composition as stated above was compounded by introducing it into a hopper and processed through a barrel and further sent for a net-extrusion process to prepare a net. The net-extrusion process was performed through a single screw extruder having counter-rotating dies. Nets were produced in a diamond mesh netting. The die system was having 55 holes and during extrusion, both the die rotates in opposite directions. The screw was rotated through a motor having a frequency in the range of 32 to 33 Hz. The motor that rotated the die had a frequency of 33-34 Hz. In the melt net-extrusion process, the temperature profile for different zones of the extruder was maintained in the range of 100° C. to 190° C. The extruded net-shaped material from the rotatory die was quenched in a first water bath having a temperature of 25° C.

The extruded net-shaped material (25 Kg) was modified after the extrusion process. In the modification process, the extruded net-shaped material was stretched in a machine direction. The process was accomplished in a water bath. The temperature of the water bath was maintained at 60° C. The extruded net structures were passed through the warm water and collected on the winder. The extent of the stretching of extruded nets in the machine direction was adjusted by the take off and winder speed. The polymer net-structure stretch ratio was maintained at 1:3 during the process. The stretched polymer net structure was collected on a winder.

Article development was performed by cutting the stretched net structure in a length of 20 inches. After cutting, one end of the net structure was sealed through a hot press machine. The obtained net bags have a diameter of 9 inches diameter and net-filament diameter was 150 microns. Each diamond mesh shape of netting had an area of 0.25 cm².

Experiment 2-4: Process of the Preparation of Biodegradable Net Bags in Accordance with the Present Disclosure

The same experimental procedure was followed for the preparation of the net bag as mentioned in experiment 1, except a different stretching ratio was used as mentioned in Table 1.

TABLE 1
Stretch ratio optimization for weight capacity:

| | | | Weight | | |
|---|---|---|---|---|---|
| | | Length | of net | Sealing | Weight |
| Experiment | Stretching | of the net | bag | Temperature | Capacity |
| No. | Ratio | (Inch) | (g) | (° C.) | (Kg) |
| 1 | 1:1 | 20 | 17 | 300 | 3.0 |
| 2 | 1:2 | 20 | 8.5 | 300 | 3.0 |
| 3 | 1:3 | 20 | 5.7 | 300 | 3.0 |
| 4 | 1:4 | 20 | 4.0 | 300 | <2.5 |

It is evident from the above table that in the net-extrusion process, the extruded tube-type netting from the extrusion die is slightly rigid and has more weight per unit length. Once netting is stretched in a certain ratio in water (say 60° C.) its weight per unit length gets decreased. It was thus observed that when the stretch ratio is 1:3, the net has the same weight capacity but the weight of the 20 inch bag becomes 5.7 g only, thus, making the net bag cost-effective.

The biodegradable net of Example 3 prepared by a stretch ratio of 1:3 was used for the evaluation of the mechanical properties. The mechanical properties of the net-bag were elevated at UTM machine at per test method ASTM D 638. The sample thickness was 0.32 mm and the width was 100 mm. The speed of the crosshead section was 50 mm/min. The results are provided in Table 2.

TABLE 2
Mechanical properties of the biodegradable net prepared
in accordance with the present disclosure:

| Sr. No. | Test Details | Test Methods | Unit | Results |
|---|---|---|---|---|
| 1 | Tensile Strength | ASTM D 638 | MPa | 12.0 |
| 2 | Elongation | ASTM D 638 | % | 112 |

It is observed from the above table that the biodegradable netting has a comparative tensile strength of the commercially available nettings, and also an optimum elongation.

Sealing optimization for weight capacity: The extruded net was sealed at one end for net-bag preparation. Sealing of net-bags at different temperatures was evaluated with 1:3 ratio stretching and weight holding capacity was determined. Further, an increase in sealing temperature was avoided due to the thermal degradation of biodegradable polymer above this temperature.

TABLE 3
Sealing optimization for weight capacity:

| | Sealing | Holding time | Weight Capacity |
|---|---|---|---|
| Sr. No. | Temperature (° C.) | (Sec) | (Kg) |
| 1 | 200 | 3 | 1.5 |
| 2 | 250 | 3 | <2.0 |
| 3 | 300 | 3 | 3.0 |

It is observed from the above table that a change in the sealing temperature affected the weight capacity of the bags. It was also observed that as the sealing temperature increased up to 300° C., the weight capacity of the bag increased. Upon further studies, it was also observed that when the sealing temperature was maintained above 300° C., the melting pattern of the edges of the net bag is hampered and the desired sealing did not take place, due to the flow of molten polymer.

### Technical Advancements

The present disclosure described herein above has several technical advantages including, but not limited to, the realization of a process for the preparation of the biodegradable net article, wherein the process:
is simple and advanced;
is comparatively economical; and
is commercially scalable,
   and
   a biodegradable net article produced by using the process of the present disclosure that:
has comparatively higher melt strength;
has comparatively higher mechanical strength;
has good flexibility, better orientability, and high tensile strength; and
is environmentally friendly.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the invention to achieve one or more of the desired objects or results. While certain embodiments of the inventions have been described, these embodiments have been presented by way of example only, and are not intended to limit the scope of the inventions. Variations or modifications to the formulation of this invention, within the scope of the invention, may occur to those skilled in the art upon reviewing the disclosure herein. Such variations or modifications are well within the spirit of this invention.

The numerical values given for various physical parameters, dimensions and quantities are only approximate values and it is envisaged that the values higher than the numerical value assigned to the physical parameters, dimensions and quantities fall within the scope of the invention unless there is a statement in the specification to the contrary.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

1. A process for the preparation of a biodegradable net article, said process comprising the following steps:
a. compounding at least one biodegradable polymer and at least one additive to obtain pellets of a biodegradable polymer composition and drying said pellets at a first predetermined temperature for a predetermined time period to obtain dried pellets;
b. extruding said dried pellets using a means for extrusion at a second predetermined temperature to obtain a plurality of individually extruded strands forming an extruded net in the form of a net sleeve, wherein said means for extrusion comprises a plurality of grooved die members having a plurality of orifices;
c. quenching said extruded net at a third predetermined temperature to obtain a quenched net;
d. stretching said quenched net at a predetermined stretch ratio in at least one fluid bath having a fourth predetermined temperature to obtain a stretched net; and
e. sealing said stretched net at a fifth predetermined temperature to obtain said biodegradable net article.

2. The process as claimed in claim 1, wherein said biodegradable polymer composition comprises at least one copolymer of aromatic diacid, aliphatic diacid, and aliphatic diol, at least one biodegradable polymer, at least one filler, optionally at least one branching agent, optionally at least one thermal stabilizer and optionally at least one compatibility agent.

3. The process as claimed in claim 1, wherein said biodegradable polymer composition comprises poly(butylene adipate-co-butylene terephthalate), poly(lactic acid) and talc.

4. The process as claimed in claim 3, wherein said biodegradable polymer composition comprises:
poly(butylene adipate-co-butylene terephthalate) having MFI (ASTM D 1238) in the range of 5 g/10 min to 8 g/10 min at 190° C., material density in the range of 1.21 g/cm³ to 1.25 g/cm³, and melting temperature in the range of 115° C. to 125° C.;
poly(lactic acid) having MFI (ASTM D 1238) in the range of 4 to 8 g/10 min at 210° C., and material density in the range of 1.25 g/cm³ to 1.28 g/cm³; and
talc having particle size 5.0±0.5μ D (50), and bulk density 375±30 g/ltr.

5. The process as claimed in claim 3, wherein said biodegradable polymer composition is characterized by having:
MFI (ASTM D 1238) in the range of 5 g/10 min to 7 g/10 min at 190° C.;
material density in the range of 1.25 g/cm³ to 1.29 g/cm³;
melting temperature in the range of 120° C. to 150° C.;
glass transition temperature of 55.0° C.; and
crystallization temperature of 91.5° C.

6. The process as claimed in claim 1, wherein said extruding comprises extrusion of a plurality of strands by rotation of at least one grooved die member in one direction and joints formed by rotation of at least one grooved die member in the opposite direction, wherein said grooved die members are coaxial.

7. The process as claimed in claim 6, wherein said forming of said extruded net comprises an opposite rotation of said grooved die members at a predetermined angular speed to extrude strands and sequentially join the strands to form said net sleeve.

8. The process as claimed in claim 7, wherein said predetermined angular speed is in the range of 125 rad/sec to 252 rad/sec.

9. The process as claimed in claim 7, wherein said die members are driven using a motor having a frequency in the range of 25 Hz to 40 Hz.

10. The process as claimed in claim 1, wherein said plurality of orifices is in the range of 40 to 80.

11. The process as claimed in claim 1, wherein said plurality of orifices is 55.

12. The process as claimed in claim 1, wherein said individually extruded stand has a thickness in the range of 50 microns to 200 microns.

13. The process as claimed in claim 1, wherein said first predetermined temperature is in the range of 60° C. to 100° C., said second predetermined temperature is in the range of 100° C. to 230° C., said third predetermined temperature is in the range of 10° C. to 30° C., said fourth predetermined temperature is in the range of 55° C. to 70° C., and said fifth predetermined temperature is in the range of 200° C. to 320° C.

14. (canceled)

15. (canceled)

16. The process as claimed in claim 1, wherein said predetermined time period is in the range of 1 hour to 4 hours.

17. The process as claimed in claim 1, wherein said fluid bath is water bath.

18. (canceled)

19. The process as claimed in claim 1, wherein said stretching is done in at least one direction selected from machine direction and transverse direction and said predetermined stretch ratio is in the range of 1:1 to 1:6.

20. (canceled)

21. (canceled)

22. (canceled)

23. The process as claimed in claim 1 wherein said additive is at least one selected from the group consisting of a filler, a branching agent, a thermal stabilizer and a compatibilizer.

24. A biodegradable net article as claimed in claim 1, comprises a biodegradable net having a plurality of strands with a predetermined thickness and a predetermined length, wherein said strands are interconnected such that each set of strands has an orifice of a predetermined diameter and article being suitable for packaging, preferably in the form of bags, wherein said article has a holding capacity in the range of 50 grams to 5 kg.

25. (canceled)

26. The article as claimed in claim 24, wherein said orifice of said biodegradable net is diamond-shaped.

27. The article as claimed in claim 24, wherein said predetermined diameter is in the range of 4 inches to 18 inches, said predetermined length is in the range of 10 inches to 30 inches, and said predetermined thickness is in the range of 50 microns to 200 microns.

28. (canceled)

29. (canceled)
